(19) United States
(12) Patent Application Publication
(10) Pub. No.: US 2024/0364521 A1
(43) Pub. Date: Oct. 31, 2024

(54) TRANSFEREE-INITIATED BLOCKCHAIN TOKEN TRANSFER

(71) Applicant: Victor W Tang, Clyde Hill, WA (US)

(72) Inventor: Victor W Tang, Clyde Hill, WA (US)

(21) Appl. No.: 18/633,314

(22) Filed: Apr. 11, 2024

Related U.S. Application Data
(60) Provisional application No. 63/549,379, filed on Feb. 2, 2024.
(60) Provisional application No. 63/462,475, filed on Apr. 27, 2023.

(51) Int. Cl. H04L 9/32; H04L 9/00

(52) U.S. Cl. CPC H04L 9/3213; H04L 9/50

(57) ABSTRACT

A blockchain token may be transferred from a current owner of the blockchain token to a different user responsive to an instruction to transfer the blockchain owner from the current owner to the other user, with or without the blockchain owner's knowledge or involvement. This may comprise a smart contract that minted the blockchain token and/or that permits transferee-initiated transfer of the blockchain token. The smart contract may further condition transferee-initiated transfer on a maximum number of blockchain tokens associated with a digital file that are permitted to be transferred to a single blockchain wallet, a maximum number of transferee-initiated transfers of a blockchain token, a maximum amount of transfer fees for transferring one or more blockchain tokens associated with a digital file, and/or a successful match of a code to a stored code.

### RELATED APPLICATION

This application is a non-provisional application that claims the benefit of priority from U.S. Provisional Patent Application No. 63/459,379, filed Apr. 14, 2023 and U.S. Provisional Patent Application No. 63/462,475, filed Apr. 27, 2023, which are incorporated by reference herein for all purposes.

### BACKGROUND

To mint a token for a digital file, such as an artwork or music, a user, such as the digital file creator, uses a blockchain platform to “tokenize” the digital file, meaning the user may use the blockchain platform to create a unique, one-of-a-kind digital certificate of ownership for that digital file. To transfer the token to a recipient, the user sends the token to the recipient's digital wallet address, which is a string of characters that uniquely identifies the recipient's digital wallet. The recipient needs to have a compatible digital wallet that supports the token standard used by the artist or creator.

Typically, to send the token, the owner of the token needs to know the recipient's wallet address, which they add to a transaction configured to transfer the token to said wallet address. The owner then signs the transaction with their private key for the token or the owner's wallet holding the token to confirm that they are the rightful owner of the token and to authorize transfer of the token to the recipient's wallet address. Once the transaction is confirmed on the blockchain, the token is transferred to the recipient, and they become the new owner with proof of ownership stored on the blockchain.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicate similar or identical items.

FIG. 1 illustrates an example network and/or systems for minting and acquiring blockchain tokens.

FIG. 2 illustrates a flow diagram illustrating an example process comprising creating a blockchain token in accordance with some examples.

FIG. 3 illustrates a flow diagram illustrating an example process comprising transferring a blockchain token in accordance with some examples.

FIG. 4 illustrates a flow diagram illustrating an example process comprising allowing or permitting a call of a transfer function for a blockchain token in accordance with some embodiments of the disclosure.

### DETAILED DESCRIPTION

The techniques (e.g., hardware and/or software) discussed herein may include a system and/or processes for minting a blockchain-based token (e.g., a non-fungible token (NFT), fungible token, or similar) and/or transferring such a token. In some examples, the techniques may comprise computer-implemented processes. Such processes may comprise setting a value of a transfer-permissions field associated with a blockchain token via a smart contract, to indicate that a transferee-initiated transfer of the blockchain token is permitted. Such processes may additionally or alternatively comprise publishing at least a summary of the blockchain token together with an indication that the transferce-initiated transfer of the blockchain token is permitted. The techniques may additionally or alternatively comprise one or more non-transitory computer readable storage media storing one or more programs, the one or more programs comprising instructions, which when executed by one or more processors, cause the one or more processors to perform such processes. The present disclosure further provides electronic devices comprising one or more processors, and memory storing one or more programs, the one or more programs comprising instructions, which when executed by the one or more processors, cause the electronic device to perform such processes.

In some examples, the techniques may additionally or alternatively comprise providing a presentation of a blockchain token on a user device, the presentation comprising a summary of the blockchain token together with an indication that a transferce-initiated transfer of the blockchain token is permitted. For example, such a summary may comprise embedded data, such as extensible markup language (XML) or other markup language data, content management system (CMS) data, search engine optimization (SEO) data and/or the like associated with the blockchain token and provided by a content server. The techniques may additionally or alternatively comprise obtaining via the user device an initiation input configured to initiate transferee-initiated transfer. For example, the initiation input may comprise user selection of a user interface element, provision of a user's wallet address via a field, and/or the like. In response to the initiation input, an application programming interface (API) call or other blockchain call may be transmitted to a blockchain transfer function (e.g., of the blockchain token's smart contract) and, so long as transferce-initiated transfer is permitted or the token has not been transferred and the token owner is the original creator of the token (this restriction can be waived if there is no restriction on the number of transferee initiated transfers of the same token), the blockchain token may be transferred to the digital wallet address (e.g., via a blockchain transaction). In some examples, the techniques may comprise displaying a representation of the blockchain token or a summary thereof in a library associated with the user when the transfer thereof has been effected. The techniques may additionally or alternatively comprise non-transitory computer readable storage media storing one or more programs, the one or more programs comprising instructions, which when executed by one or more processors of, cause the one or more processors to perform such methods. The techniques may additionally or alternatively comprise an electronic device comprising one or more processors, and memory storing one or more programs, the one or more programs comprising instructions, which when executed by the one or more processors, cause the electronic device to perform such methods.

In some examples, the techniques may comprise computer-implemented methods. Such methods may comprise receiving a transfer function call, from a function caller (e.g., a device associated with a user or an API call identifying a digital wallet address), in respect of a blockchain token, the transfer function being configured to effect transfer of the blockchain token from a current owner thereof to a new owner. For example, the transfer function may be part of a smart contract. Such methods may comprise determining whether the function caller is the current owner of the blockchain token. Such methods may additionally or alternatively comprise determining whether a transfer-permissions field associated with the blockchain token, such as in a smart contract associated with the blockchain token, indicates that a transferee-initiated transfer of the blockchain token is permitted. Such methods may comprise blocking the transfer function call unless it is determined that at least one of the following is true: the function caller is the current owner of the blockchain token; or the transfer-permissions field indicates that a transferee-initiated transfer of the blockchain token is permitted or a number of times the token is permitted to be transferred or permitted to be transferred to a specific transferee or digital wallet is less than a threshold number. The present disclosure further provides non-transitory computer readable storage media storing one or more programs, the one or more programs comprising instructions, which when executed by one or more processors of an electronic device, cause the one or more processors to perform such methods. The present disclosure further provides electronic devices comprising one or more processors, and memory storing one or more programs, the one or more programs comprising instructions, which when executed by the one or more processors, cause the electronic device to perform such methods.

It will be appreciated that a feature described in relation to any one of the aspects, examples, or features herein may be applied to any other aspect, example, or feature. Any aspect, example, or feature may form part of an example or may be an example in its own right.

### Example Environment

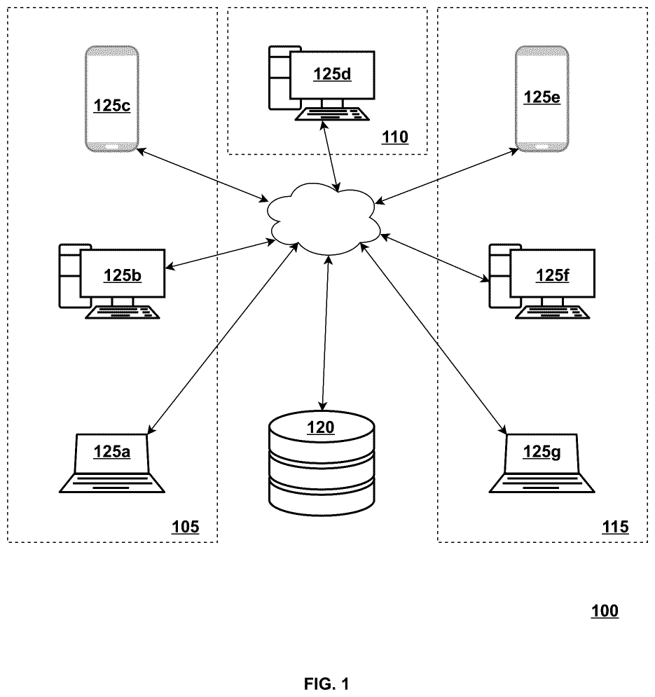

Referring to FIG. 1, a network 100 according to an embodiment of the present disclosure enables an ecosystem comprising content creators 105 (e.g., first user(s)) who use a blockchain network 110 to mint fungible tokens or non-fungible tokens (NFTs) associated with their creative works (e.g., a file, such as an image, video, audio, or the like), and communities of fans 115 (e.g., second user(s)) of the content creators who are interested in acquiring the blockchain tokens. It will be appreciated that said ecosystem is merely a non-limiting example of an ecosystem which is enabled by the network 100. Moreover, the content creators 105 may comprise one or more content creators and the fans may comprise one or more second users.

In overview, the blockchain network 110 provides a decentralized platform for the content creators 105 (or other entities) to mint blockchain tokens, which represent unique digital assets. Typically, each blockchain token is created using a smart contract, which may include a programmable agreement token to be transferred, bought, and sold without the need for intermediaries. For example, the programmable agreement token (i.e., a smart contract) may comprise a set of processor-executable instructions that are available for access by other devices participating in the blockchain. Any call to the smart contract and/or execution of the smart contract can be confirmed by other devices participating in the blockchain, such as mining devices, before and/or after the instructions are executed. The Ethereum blockchain, for example, also supports a native cryptocurrency, Ether, which may be used to pay transaction fees (“gas”) and other costs associated with using the network, although any suitable blockchain network may be used, such as Solana, Terra, Avalanche, and/or the like.

The content creators 105 comprise a diverse group of individuals, organizations, and/or autonomous agents (e.g., machine-learned model(s), artificial intelligence, or the like) who/that produce creative works in various fields, such as music, art, video games, collectibles, and/or the like, or other file(s) created by a user, such as text, documents, audio files, video files, 3D files, and/or the like. Each blockchain token may be associated with a specific file, such as an audio file, a video file, image file, a text/document file, a 3D file, parameter(s) of a video game (e.g., a skin, video game feature, alteration of base video game parameter(s)), and/or the like. The blockchain tokens provide a means for such a user to distribute, market, and monetize their work and establish a direct relationship with their respective fan bases, or at least a second user. It will be appreciated that, within the scope of the present disclosure, there is no limitation on which entities may mint blockchain tokens or on what distributed ledger (e.g., blockchain) the minted blockchain tokens are associated with.

The communities of fans 115 may comprise supporters of the creative works associated with the blockchain tokens, or at least a second user seeking to acquire ownership of a digital file for which a blockchain token was created by the original owner or creator of the digital file. A second user may acquire a blockchain token (and, in some examples, the digital file associated therewith) through auctions, sales, or other means, and in doing so, they may obtain a unique and authentic digital asset. The fans may also trade or sell the blockchain tokens on secondary markets, providing liquidity and value to the blockchain token ecosystem. It will be appreciated that, within the scope of the present disclosure, there is no limitation on which entities may acquire, trade, or sell the blockchain tokens.

Creative content, such as a digital file, associated with a blockchain token may be stored on a storage system 120 such as the Inter Planetary File System (IPFS), which is a decentralized and distributed file system that provides permanent and tamper-proof storage of digital assets, although in additional or alternate examples, the creative content may be stored in any other blockchain token owner-accessible storage. The IPFS system uses a content-addressed method for accessing data, which means that the content is identified by its hash, rather than its location. This allows for efficient and redundant storage of the creative content, as well as decentralized and censorship-resistant access to the content. In various embodiments, alternative storage systems may be used, such as dedicated webservers, cloud storage solutions, or the like.

Referring again to FIG. 1, the network 100 may comprise a plurality of electronic devices 125a-125g configured for communication with each other over a communications network 130 such as the Internet. The electronic devices 125a-125g can execute software for creating, minting, and trading tokens on the blockchain. The electronic devices 125a-125g may take many forms, such as, without limitation, personal computers, smartphones, tablets, Internet of things (IoT) devices, web servers (e.g., one or more central processing unit(s) (CPU(s)), graphics processing unit(s) (GPU(s)), tensor processing unit(s) (TPU(s)), and/or memory; and/or a cluster thereof), application specific integrated circuit(s) (ASIC(s)), and/or the like. Note that CPU(s), GPU(s), TPU(s), ASIC(s), field-programmable gate arrays, and/or the like are all examples of processor(s). Personal computers (PCs) are a common type of device used to execute the software involved in creating, minting, and trading tokens on the blockchain. PCs come in different forms, including desktops and laptops, and can run different operating systems, such as Windows, macOS, and Linux. Smartphones are increasingly being used to execute the software involved in creating, minting, and trading tokens on blockchains such as the Ethereum blockchain. Most modern smartphones can run electronic/digital wallet software, and some even support the execution of decentralized applications (dApps) on blockchains. Tablets are similar to smartphones in terms of their capabilities, and can also be used to execute the software involved in creating, minting, and trading tokens on blockchains. Some users prefer to use dedicated hardware wallets to store and manage their blockchain assets, including blockchain tokens, and may be considered an electronic or digital wallet. These hardware wallets are designed to be secure and can be connected to PCs or smartphones for case of use. Some Internet of Things (IoT) devices, such as smart home devices and sensors, can also be used to execute software involved in creating, minting, and trading tokens on the Ethereum blockchain. For example, an IoT device may be programmed to automatically purchase a blockchain token from a blockchain token marketplace platform when certain conditions are met.

The electronic devices 125a-125g may be configured to communicate with one another using different protocols and technologies. Devices which are part of the blockchain network 110, including personal computers, smartphones, tablets, and IoT devices, typically use the Internet Protocol (IP) to communicate with each other over the Internet. A blockchain protocol, such as, without limitation, the Ethereum Protocol, the Algorand Protocol, the Cardano Protocol, the Solana Protocol, may be used by devices running blockchain node software to communicate with each other over the blockchain. The Ethereum Protocol, for example, is designed to enable the execution of smart contracts and the transfer of Ether and other Ethereum-based assets, including tokens. Some applications and services in the blockchain ecosystem, such as IPFS storage clients and some decentralized exchanges, use peer-to-peer (P2P) networks to facilitate communication between devices. P2P networks enable devices to communicate directly with each other, without the need for a centralized intermediary. Further, devices such as smartphones and IoT devices can communicate with each other over wireless technologies such as Wi-Fi-based communication such as via frequencies defined by the IEEE 802.11 standards, ultra-high frequency (UHF) (e.g., Bluetooth®, satellite), cellular communication (e.g., 2G, 3G, 4G, 4G LTE. 5G, etc.), and Near Field Communication (NFC). It will be appreciated that some services in the blockchain ecosystem, such as blockchain token marketplaces and blockchain explorers, provide APIs that enable devices to access data and interact with the service programmatically. APIs enable devices to communicate with each other over the internet using standard protocols and data formats.

The electronic devices 125a-125g may comprise several types of software that play different roles in enabling the creation, minting, trading, and storage of fungible or non-fungible tokens on the blockchain. Blockchain node software runs the blockchain, and it is responsible for validating transactions, executing smart contracts, and maintaining the state of the blockchain. Ethereum client software, for example, may include Geth, Parity, and OpenEthereum. Smart contract development software tools enable content creators to develop and deploy smart contracts on the blockchain and to mint blockchain tokens. Examples of smart contract development tools include Solidity. Vyper, and Truffle. Wallet software may be used to store, manage, and transfer blockchain-based assets, including blockchain tokens. Examples of wallet software include MetaMask. MyEtherWallet, and Ledger Live. Token marketplace platforms may enable content creators to list and sell their blockchain tokens to fans, who can then buy, sell, or trade the blockchain tokens on secondary markets. Examples of blockchain token marketplace platforms include OpenSea, Rarible, and SuperRare. IPFS storage clients enable users to store and access digital content on the IPFS. Examples of IPFS storage clients include IPFS Desktop, Pinata, and Infura.

A blockchain network 102 may comprise various nodes, depicted as computing device(s) in the figures. In some examples, the nodes that participate in a blockchain network may individually store a copy of that particular blockchain's ledger. Nodes that participate in the blockchain may comprise node(s) that transact on a blockchain node by operating on the blockchain ledger by requesting a follow-on token to be minted, transacting token(s), destroying token(s), etc.

Requests from transacting nodes to mint/transact/destroy/etc., may be transmitted to one or more mining nodes of the blockchain network. In some examples, such requests are transmitted to all mining nodes participating in the blockchain network for mining node(s) thereof to verify conformance of the request to protocols associated with the blockchain and to solve a proof of work problem or determine a proof of stake. Upon determining that the request comports with the protocols of the blockchain or the type of token requested, a mining node may attempt to be the first to solve a proof of work problem and/or determine a proof of stake for the request. If the mining node solves the proof of work and/or determines the proof of stake before receiving a notification that another mining node has done so, the mining node may transmit a notification to the other mining nodes that includes the proof of work or proof of stake along with the requested operation on the blockchain ledger. So long as 51% or more of the miners affirm that this notification from the mining node is valid, the operation is then concatenated to the blockchain ledger, which may include concatenating a notification that a follow-on token has been minted along with what wallet holds the token, a transaction between wallets, a destruction of a token, a function executed by a smart contract, and/or the like.

Any device participating in a blockchain network may be a node of one or more blockchain networks by virtue of sending requests, via network(s) 108, to a blockchain network (i.e., to create transactions on that specific blockchain), reading from the blockchain ledger, and/or potentially storing a copy of a blockchain ledger or salient portion(s) of the blockchain ledger at the device. Each node in the blockchain network is interconnected to several other nodes, forming a fault-tolerant peer-to-peer network. Should a host node become unavailable, a participating device would connect to an alternate node within the blockchain network. For example, a device may determine a salient portion of the blockchain ledger by determining that such a portion of the blockchain ledger is the result of request(s) sent by the device to the blockchain network and/or the result of subsequent transaction(s) regarding a token that the device requested to be minted.

In some examples, the salient portion of the blockchain ledger may further comprise a portion that the device predicts will be added to the blockchain ledger as a result of a request sent by the device to mining node(s) of a blockchain network in anticipation of the mining node(s) executing the request. In some examples, this predicted portion of the blockchain ledger that the device stores may comprise an indication that such a portion is merely predicted until a confirmation of execution of the request is received from the blockchain network (e.g., by receiving notification of a newly added block that includes execution of a request transmitted by the device). The device may reduce the latency associated with mining by storing this predicted portion of a blockchain ledger instead of waiting for the block to be added by a mining node.

In some examples, a host computing system may receive a request from a user device associated with a user to mint a new blockchain token having the configuration discussed herein. In some examples, the user device may have a mobile wallet application stored thereon or a browser that accesses a webpage hosted by the host computing system. For example, the host computing system may store and/or execute a user component that may provide hosted services for the user device to communicate with and/or access, such as via an API. The host computing system may receive the data and/or indications discussed herein from the user device, such as via a user interface of the user device. In some examples, a first portion of the data may be used to populate a data structure that is compliant with an NFT creation protocol, such as ERC 721, ERC 1155, Solana NFT. Solana Cardinal, MANA token, Origin protocol, One Sat Ordinal, or the like. For example, a first portion of the blockchain token may comprise a link to a metadata file which additionally includes links to digital file(s) and/or XML, CMS, and/or SEO data, any of which may be stored in a distributed storage system, such as IPFS, that are to be part of a newly minted project token; an address of a wallet associated with an owner of the created token; processor-executable instructions and/or other smart contract data; and/or the like. In some examples, the wallet associated with the owner may be accessed via a mobile wallet application stored and executed on a device or may be a hardware wallet.

### Example Process(es)

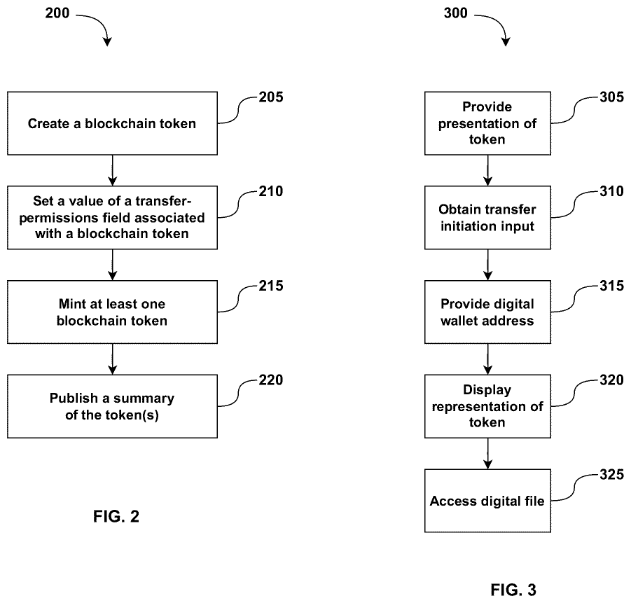

As shown in FIG. 2, at least one of the electronic devices 125a-125c associated with a content creator is configured to perform an example process 200 of minting at least one blockchain token on a blockchain.

At operation 205, example process 200 may comprise creating at least one blockchain token, according to any of the techniques discussed herein. This may comprise deploying a smart contract and creating the blockchain token according to the smart contract. For example, the content creator may use a smart contract development software tool to create and deploy a custom smart contract that defines the blockchain token's properties and behavior. The smart contract may be based on a suitable template or standard, such as an ERC20, ER721, or ERC1155 smart contract for Ethereum blockchains; it may be created using the Algorand Standard Asset (ASA) protocol; it may use the Solana Token Program; and/or the like. The smart contract may include a minting function that creates one or more new blockchain tokens when called (e.g., by transmitting to the blockchain network a request to mint a new token responsive to the call). The smart contract may comprise a transfer function for effecting transfer of a minted blockchain token from its current owner to a new owner. For example, the transfer function may be called by any device, such as via an API or via the blockchain network, with instructions to transfer an existing token from a digital wallet associated with a current owner of the token to another digital wallet.

In order to mint a blockchain token for a digital file, such as a short video clip, the content creator would typically need to interact with the smart contract through a user interface that communicates with the blockchain network. The user interface would allow the content creator to input the necessary information, such as the video clip's metadata, the number of blockchain tokens to mint, and pay any associated fees or gas costs. The user interface may be designed to guide the content creator through the minting process. The form may include fields for the video clip's title, description, and URL, as well as options for setting the blockchain token's name, symbol, and total supply. For example, the total supply may indicate how many tokens are available to purchase that all indicate ownership of the video clip. In some examples, this may be one token per file, although in other examples, the total supply may be more than one or infinite. Additionally or alternatively, the form may include a field to indicate a designated wallet with a balance to pay transaction fees (e.g., gas) to fund the transfer of token(s) associated with the digital file. For example, this limit may be used in addition to (e.g., whichever maximum is reached first) or instead of the total supply.

At operation 210, example process 200 may comprise setting a value of a transfer-permissions field associated with the blockchain token, according to any of the techniques discussed herein. For example, the transfer-permissions filed may indicate the permitted count of transferee-initiated transfers of the blockchain token by a transferce (e.g., maximum transfers to a unique wallet address, maximum total transfers, maximum transfers of the token, etc. any of which may be enforced separately or in combination). This may be done via the user interface by selecting a value from a drop-down menu, selecting a radio button, checking a box, typing in a value, or any other suitable user interface element (e.g., via audio, gestures, neural input). Unlike, for example, ERC20, ER721, or ERC1155 smart contracts, when the transfer-permissions field is set to this value, the transfer function is not locked to the blockchain token's current owner. For example, the transfer function may be universally callable when transferce-initiated transfer of the blockchain token is permitted. In other words, unlike other smart contracts, even a wallet that does not have ownership of the token may transfer ownership of the token to a wallet that's not associated with the owner of the token. In some examples, the transfer-permission may additionally or alternatively indicate that a code (e.g., PIN number, password, hash) that needs to be supplied by the transferce and match a code stored on a host computing device.

At operation 215, example process 200 may comprise minting the at least one blockchain token on a blockchain, according to any of the techniques discussed herein. This may comprise clicking a “mint” button to initiate a minting transaction once the content creator has filled in the necessary information. The user interface may then display a confirmation screen with the gas fees and any other associated costs, allowing the content creator to review and approve the transaction before it is broadcast to the blockchain network.

After the transaction is approved and broadcast, the smart contract creates the specified number (which can be 1 or more) of blockchain tokens and assigns them to the content creator's or other designated blockchain wallet. The user interface may then display a confirmation screen with the transaction hash and any additional details, allowing the content creator to verify that the blockchain token(s) have been minted successfully.

At operation 220, example process 200 may optionally comprise publishing a summary of the blockchain token together with an indication that the transferce-initiated transfer of the blockchain token is permitted, according to any of the techniques discussed herein. The summary may comprise a summary (e.g., a representation, condensed data of) of the digital file associated with the blockchain token. For text-based digital files such as documents or articles, the summary may comprise a brief summary or excerpt of the content along with metadata such as the title, author, and date of creation. For digital files representing images or artwork, the summary may comprise a thumbnail or preview of the content (which may be watermarked and/or relatively low-resolution) along with metadata such as the title, artist, and date of creation. For digital files representing audio or video content, the summary may comprise a thumbnail or preview image (which may be watermarked and/or relatively low-resolution) or short audio or video clip (which may be of reduced quality) along with metadata such as the title, artist, and duration of the content. In some examples, the token may further comprise metadata linking the token to SEO, CMS. XML, and/or similar data that may be used by a web server to generate a summary of the token. In such an example, the owner of the token may share to a website, mobile or desktop application, dApp, or the like a representation or summary of the token. In such an example, the representation or summary may comprise embedded data in a website or application that presents and/or includes the metadata associated with the token. For example, the summary and/or representation may display a representation of the digital file associated with the blockchain token, such as a downsampled, downscaled, snippet, portion, or other representation of the digital file. XML or other markup data associated therewith to format presentation of such a representation and/or may embed SEO and/or CMS data (visibly as tags or invisibly in data that is embedded in the webpage or application) in association with the presentation.

In some examples, the blockchain token may be represented by a unique URL pointing to a webpage displaying summary details of the blockchain token. e.g. including the title, description, author, preview(s), searchable keywords, and an input enabling transferee-initiation of transfer of the blockchain token. Additionally or alternatively, operation 220 may comprise uploading XML or other markup data. CMS data, and/or SEO data to a host server for a dedicated website or landing page that showcases the new blockchain tokens, in addition to or instead of embedding such data on another webpage or within an application's user interface. The website (or embedded data) may include a description of the blockchain token and its associated content, as well as a link to the smart contract and a wallet address for a user to send payment or to cause the token to be transferred to the user without payment by the user (e.g., where the transaction fee is paid from a wallet associated with the current token owner or third party). The website may comprise embedded metadata for social media websites to facilitate sharing of the website and associated blockchain token. The content creator may drive traffic to the website using social media platforms to announce the release (and, optionally, availability by means of a transferce-initiated transfer) of the new blockchain tokens and linking to the website. The blockchain token may comprise a pointer to the dedicated website or landing page; for example, a canonical URI of the blockchain token may comprise an address of the dedicated website or landing page.

In some examples, transferce-initiated transfer of blockchain tokens may simplify processes whereby the blockchain tokens are intended to be transferred to as-yet unknown recipients. Rather than a pre-step of obtaining wallet addresses of interested parties, and then submitting transactions for the transfer to interested parties who provided their wallet addresses, the blockchain tokens can simply be minted with transferce-initiated transfer enabled, and then interested parties can obtain the blockchain tokens of their own volition (while there is available supply, a unique transferee limit has not been met, a transfer limit for a specific token has not been met, and/or subject to PIN requirements) without any further interaction with the minter of the blockchain tokens.

As shown in FIG. 3, an electronic device associated with a user may transfer ownership of a blockchain token and, in some examples, a digital file associated therewith, by executing an example process 300. For example such a blockchain token may be minted in accordance with example process 200.

At operation 305, example process 300 may comprise providing a presentation of a blockchain token via a user device, according to any of the techniques discussed herein. The presentation may comprise presenting, via a user interface (e.g., a visual display, audio presentation, haptic presentation), a summary of the blockchain token together with an indication that a transferce-initiated transfer of the blockchain token is permitted. Such indication that the transferce-initiated transfer may include a user interface element that is activatable by user input (e.g., a user interface element with text or audio that indicates the user may activate the user interface element to transfer ownership of the blockchain token and/or digital file to the user). The presentation may be provided within a user interface of the user's digital wallet or via any other suitable method. The presentation may additionally or alternatively indicate the available supply of such blockchain tokens.

The digital wallet user interface may consist of a main presentation (e.g., a visual display, an audio representation, a haptic representation) that displays the user's blockchain token library as a visual grid or list of thumbnail images, e.g., with each blockchain token represented by a unique image or logo in an example where the available digital files are a video or image. The user may scroll through the library or use a search bar to find a specific blockchain token. Tapping on a blockchain token thumbnail may present a detailed view of the selected blockchain token, including its name, creator, and a visual representation of the blockchain token. The detailed view may also include a section for the content associated with the selected blockchain token, which may include images, video, music, or other multimedia files. The user may navigate through the content using an intuitive interface, such as a swipe gesture or a series of buttons.

The presentation of a blockchain token may be provided in a section of the digital wallet user interface which is for blockchain tokens that the digital wallet owner does not yet own but may wish to acquire. The blockchain token may comprise a URI which points to a digital file or metadata containing summary data related to the digital file and/or an additional URI to the digital file itself. The summary of the blockchain token may comprise a summary of the digital file. For text-based digital files such as documents or articles, the wallet interface may display a brief summary and/or excerpt of the content along with metadata such as the title, author, and date of creation. For digital files representing images or artwork, the wallet interface may display a thumbnail or preview of the content (which may be watermarked and/or relatively low-resolution) along with metadata such as the title, artist, and date of creation. For digital files representing audio or video content, the wallet interface may display a thumbnail or preview image (which may be watermarked and/or relatively low-resolution) or a short audio or video clip along with metadata such as the title, artist, and duration of the content. This watermarked file, thumbnail, or otherwise downsampled digital file may be part of the metadata associated with the blockchain token (e.g., via a first URI) or may be stored in IPFS or another form of storage and may be linked to with a second URI in the metadata. In other words, the metadata may contain a summarized version of the file (e.g., downsampled and/or watermarked image or frames from a video, a portion of audio, and/or the like), a link to the summarized version of the file, and/or a link to the digital file itself that may be used by an owner of the blockchain token to access the file. Note that the digital file itself may be encrypted using a seed or key generated by transfer of the blockchain token to a current owner of the blockchain token. Accordingly, accessing the digital file may comprise providing a private key to demonstrate ownership of the digital file and to decrypt the digital file as part of accessing the digital file. Accessing the digital file may comprise downloading, streaming, and/or viewing an unwatermarked, unsampled/uncompressed, and/or entire original version of the digital file.

The indication that a transferce-initiated transfer of the blockchain token is permitted may be in the form of a “claim” button or similar call-to-action displayed in connection with the blockchain token.

At operation 310, example process 300 may comprise obtaining a transfer initiation input, according to any of the techniques discussed herein. For example, the transfer initiation input may be provided via/responsive to user input to a user device. This may comprise the user clicking the “claim” button or otherwise activating a user interface element to cause the transfer, which would initiate a process to acquire the blockchain token, and may trigger a confirmation dialog or other interface element to ensure that the user intended to do so.

At operation 315, example process 300 may comprise providing 315 a digital wallet address associated with the user and effecting transfer of the blockchain token to the digital wallet address, according to any of the techniques discussed herein. This may comprise calling a transfer function of a smart contract associated with the blockchain token, the transfer function being configured to transfer the blockchain token from its current owner to a new owner. The process may comprise providing the digital wallet in the call to the transfer function. In some examples, operation 316 may additionally or alternatively comprise creating a digital wallet for the user if the user does not already have a digital wallet or the user wants to create a new digital wallet and providing that new digital wallet's address via the transfer function call. After the user has requested to acquire the blockchain token, the digital wallet may display a visual representation of the blockchain token in a separate section of the user interface, such as a “requested tokens” or “pending acquisitions” area. This section may display the blockchain token's name, creator, and other relevant details, as well as a status indicator to indicate whether the request is pending or has been fulfilled.

In some examples, operation 315 may additionally or alternatively comprise providing a PIN number or other code or password provided to the user for transferring the token. In some examples, such a code may be provided to a user in a message or redeemable for n number of transfers of a specific token, token(s) associated with a digital file, and/or transfer(s) from a particular owner of token(s).

At operation 320, example process 300 may comprise displaying a representation of the blockchain token in a library associated with the user when the transfer thereof has been effected, according to any of the techniques discussed herein. The digital wallet may automatically add the blockchain token to the user's library, and move the blockchain token from the “requested tokens” or “pending acquisitions” section to the main token library display. If the request is unsuccessful, the digital wallet may display a message indicating that the request was denied, along with any relevant details or instructions for the user to try again later.

At operation 325, example process 300 may comprise accessing the digital file via the digital wallet associated with the user, according to any of the techniques discussed herein. The digital wallet may be configured with a user interface that permits different file types to be presented to the user from within the digital wallet. The wallet may display text-based content (e.g., documents, articles, etc.) directly within the wallet interface, similar to how a document viewer app might work on a computer or mobile device. This would enable the user to scroll through the text, zoom in and out, and interact with other features such as bookmarks, highlighting, and search. The wallet may display video and audio content by embedding a media player within the wallet interface. This would enable the user to play such content directly within the wallet, and interact with standard media player controls such as play/pause, skip, and volume. The wallet may display images by rendering them within the wallet interface. This would enable the user to zoom in and out on an image, view it in full-screen mode, and interact with other features such as metadata, display, and sharing options. Additionally or alternatively, the digital wallet may allow, via blockchain network authentication of the user's ownership of the wallet and the blockchain token, a user device associated with the wallet to download the digital file.

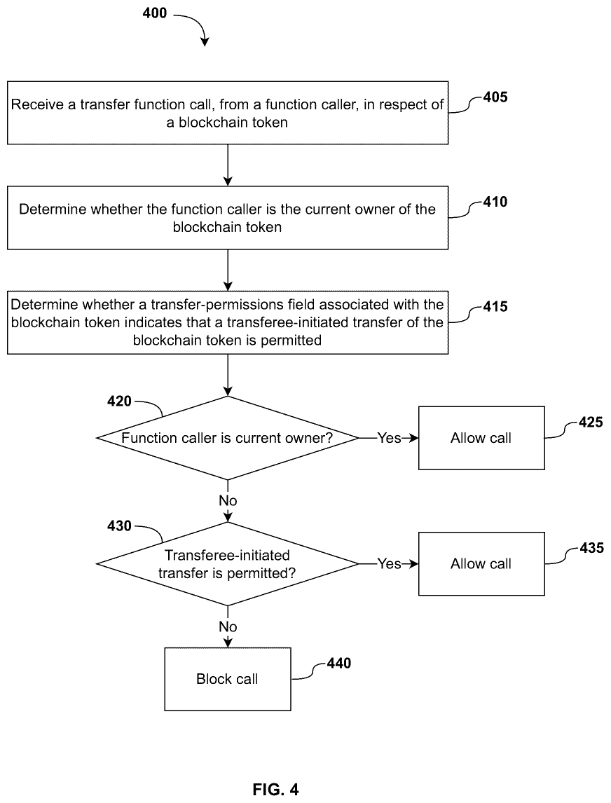

In some examples, an electronic device associated with a node of a blockchain network is configured to effect transfers of blockchain tokens minted on the blockchain, including performing an example process 400 as shown in FIG. 4. In some examples, example process 400 may be executed by a blockchain node of the blockchain network.

At operation 405, example process 400 may comprise receiving a transfer function call, from a function caller, in respect to a blockchain token, according to any of the techniques discussed herein. In some examples, the transfer function may be part of a smart contract and may transmit a request to transfer a blockchain token from wallet associated with an owner of the blockchain token to a wallet associated with a transferce, according to the techniques described herein. The call may be received from a wallet application associated with a user (e.g., the transferce or the owner) and being configured to interact with the blockchain network. The call may include the address of the smart contract and/or the name of the transfer function. The call may additionally or alternatively include a digital wallet address associated with the function caller, e.g., a wallet application, API, a web application, and/or the like. The call may include various parameters, such as the number of tokens being transferred, a PIN (or the like), and/or data from the blockchain that may be augmented with the call by the receiver of the call or the function caller itself. For example, this blockchain data may indicate a number of tokens associated with the digital file previously transferred to the wallet address of the transferce, a number of times the token has been transferred previously, a remaining number of token(s) in the supply associated with the digital file, determining whether a wallet address identified as the originator of the call is associated with a current owner of the token, and/or the like.

At operation 410, example process 400 may comprise determining whether the function caller is the current owner or creator of the blockchain token, according to any of the techniques discussed herein. This may comprise comparing a digital wallet address received from the function caller with an address associated with the current owner of the blockchain token as recorded in the smart contract. Additionally or alternatively, operation 410 may comprise determining any previous transactions associated with the digital wallet address that refer to the blockchain token. If any are discovered, a chain of title may be determined to determine whether the digital wallet address associated with the function caller is a current owner or creator of the blockchain token.

At operation 415, example process 400 may comprise determining whether a transfer-permissions field associated with the blockchain token indicates that a transferce-initiated transfer of the blockchain token is permitted, according to any of the techniques discussed herein. The blockchain token and/or the smart contract associated therewith may comprise the transfer-permissions field. In some examples, the transferce-permissions field may additionally or alternatively indicate a maximum number of transfers associated with the digital file per wallet address, a maximum number of transfers associated with the blockchain token per wallet address, a maximum number of transferee-initiated transfers of a specific blockchain token permitted, a maximum amount of transaction fees permissible for a digital file/whether a digital wallet for funding transactions has a positive balance, and/or the like.

At operation 420, example process 400 may comprise determining whether a function caller is a current owner of the blockchain token, according to any of the techniques discussed herein. If the function caller is the current owner of the blockchain token, example process 400 may continue to operation 425, where example process 400 may permit the call and, accordingly, permit the token transfer to the second user. This may occur when the current token owner initiates the transfer. Otherwise, example process 400 may continue to operation 430

At operation 430, example process 400 may comprise determining whether the transfer-permissions field indicates transferce-initiated transfer of the blockchain token is permitted, according to any of the techniques discussed herein. For example, operation 430 may comprise determining whether a smart contract or the blockchain token itself indicate that transferee-initiated transfer is permitted. If the transferee-initiated transfer is permitted, example process 400 may transition to operation 435, where the example process 400 allows the call; otherwise, operation 430 may transition to operation 440 where example process 400 blocks the call. Operation 430 may additionally or alternatively determine whether a number of transfers of blockchain tokens associated with the digital file to the digital wallet address meets or exceeds a maximum number of transfers associated with the digital file per wallet address, whether a number of transferee-initiated transfers of the blockchain token meets or exceeds a maximum number of transferce-initiated transfers of a specific blockchain token permitted, whether an amount of transaction fees for transferring token(s) associated with the digital file or of the blockchain token itself meet or exceed the available balance of a funding wallet designated for the token (or multiple tokens associated with a same digital file) in the smart contract or a maximum amount of transaction fees permissible for a digital file, whether a digital wallet for funding transactions has a positive balance, whether a number of tokens already transferred from a supply of tokens meets or exceeds a threshold number of tokens indicated by the supply, and/or the like. If any of these thresholds have been met or exceeded, example process 400 may continue to operation 440; otherwise, example process 400 may continue to operation 435. Where a funding wallet has been designated by a token creator, the fees associated with the transfer may be deducted from the funding wallet instead of from the transferee's wallet. In some examples, determining whether any of these thresholds has been met or exceeded may comprise scanning a blockchain ledger for previous transactions associated with the digital file and/or the blockchain token and/or receiving data from the smart contract. Additionally or alternatively, operation 430 may comprise determining whether a PIN (or equivalent) provided in the call matches a PIN specified as required for the transferee-initiated transfer. If the PIN matches a PIN stored in the token metadata or the smart contract, the call may be authorized at operation 435; otherwise, the call may be blocked at operation 440. This PIN may be stored as a one-way hash or use another mechanism to prevent the discovery of the PIN, providing security to ensure only users with which the token creator has shared the PIN are able to initiate transfer. Moreover, although a PIN is discussed, any other suitable code may be used, such as a password, passphrase, hash, or the like.

### CONCLUSION

Various instructions, methods and techniques described herein may be considered in the general context of computer-executable instructions, such as program modules stored on computer-readable media, and executed by the processor(s) herein. Generally, program modules include routines, programs, objects, components, data structures, etc., for performing particular tasks or implementing particular abstract data types. These program modules, and the like, may be executed as native code or can be downloaded and executed, such as in a virtual machine or other just-in-time compilation execution environment. Typically, the functionality of the program modules may be combined or distributed as desired in various implementations. An implementation of these modules and techniques may be stored on computer storage media or transmitted across some form of communication media. Examples of non-transitory computer-readable medium may include, for example, volatile or non-volatile memory, such as random access memory (RAM), static random access memory (SRAM), hard disk(s), and/or the like.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The modules and/or components described herein represent instructions that can be stored in any type of computer-readable medium and can be implemented in software and/or hardware. All of the methods and processes described above can be embodied in, and fully automated via, software code modules and/or computer-executable instructions executed by one or more computers or processors, hardware, or some combination thereof. Some or all of the methods can alternatively be embodied in specialized computer hardware.

Conditional language such as, among others, “can,” “could.” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. can be either X. Y. or Z, or any combination thereof, including multiples of each element. Unless explicitly described as singular. “a” means singular and plural.

While one or more examples of the techniques have been described, various alterations, additions, permutations and equivalents thereof are included within the scope of the techniques.

In the description of embodiments, reference is made to the accompanying drawings that form a part hereof, which show by way of illustration specific embodiments of the claimed subject matter. It is to be understood that other embodiments may be used and that changes or alterations, such as structural changes, may be made. Such embodiments, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other embodiments using alternative orderings of the computations could be readily implemented. In addition to being reordered, the computations could also be decomposed into sub-computations with the same results.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions can be deleted, or executed out of order from that shown or discussed, including substantially synchronously or in reverse order, depending on the functionality involved as would be understood by those skilled in the art.

It should be emphasized that many variations and modifications can be made to the above-described examples, the elements of which are to be understood as being among other acceptable examples. All such modifications and variations are intended to be included herein within the scope of this disclosure and protected by the following claims.

What is claimed is:

1. One or more non-transitory computer readable storage media storing processor-executable instructions that, when executed by one or more processors, cause the one or more processors to perform operations comprising:
transmitting instructions to store a smart contract on a blockchain network, the smart contract comprising a function that permits a transferee to transfer a blockchain token from a current owner of the blockchain owner to the transferee;
transmitting, by a second function of the smart contract, instructions to mint, via the blockchain network, the blockchain token; and
publishing a summary of the blockchain token with an indication that the transferee-initiated transfer of the blockchain token is permitted.

2. The one or more non-transitory computer readable storage media of claim 1 wherein the function permits the current owner or any other user to transfer the blockchain token.

3. The one or more non-transitory computer readable storage media of claim 1 wherein the smart contract comprises a transfer function for effecting transfer of the blockchain token from the current owner to the transferee.

4. The one or more non-transitory computer readable storage media of claim 1 wherein the function permits transfer of the blockchain token based at least in part on receiving a call to the function comprising instructions to transfer the blockchain token to a blockchain wallet address associated with the transferee and identifying the transferee as the originator of the call, unless the operations further comprise determining that a number of transfers of one or more blockchain tokens associated with a digital file to the blockchain wallet address meets or exceeds a maximum number of transfers associated with the digital file per wallet address or for the digital file.

5. The one or more non-transitory computer readable storage media of claim 1 wherein the function permits transfer of the blockchain token based at least in part on receiving a call to the function comprising instructions to transfer the blockchain token to a blockchain wallet address associated with the transferee and identifying the transferee as the originator of the call, unless the operations further comprise at least one of:
determining that a number of transferee-initiated transfers of the blockchain token meets or exceeds a maximum number of transferee-initiated transfers of the blockchain token; or
determining an amount of transaction fees for transferring at least one of the blockchain token or one or more blockchain tokens associated with a digital file meets or exceed a maximum amount of transaction fees indicated by the smart contract or token data associated with the blockchain token, or a current balance of a funding wallet indicated by the smart contract or the token data.

6. The one or more non-transitory computer readable storage media of claim 1 wherein the function permits transfer of the blockchain token based at least in part on receiving a call to the function comprising instructions to transfer the blockchain token to a blockchain wallet address associated with the transferee and identifying the transferee as the originator of the call, unless the operations further comprise determining that a code provided in association with the call does not match any of one or more codes indicated by the smart contract or token data associated with the blockchain token.

7. The one or more non-transitory computer readable storage media of claim 1 wherein the smart contract is configured to alter the function, in response to the blockchain token being transferred to the transferee, to indicate that a further transferee-initiated transfer of the blockchain token is not permitted.

8. The one or more non-transitory computer readable storage media of claim 1 wherein the function permits transfer of the blockchain token only by a call created by the current owner when transferee-initiated transfer of the blockchain token is not permitted by the function.

9. The one or more non-transitory computer readable storage media of claim 1 wherein the blockchain token comprises a uniform resource identifier (URI) or uniform resource locator (URL) that points to a digital file or metadata that comprises a link to the digital file.

10. The one or more non-transitory computer readable storage media of claim 9 wherein the summary of the blockchain token comprises a summary of the digital file.

11. A system comprising:
one or more processors; and
memory storing instructions that, when executed by the one or more processors, cause the one or more processors to perform operations comprising:
providing a presentation of a blockchain token via a user device, the presentation comprising a summary of the blockchain token with an indication that a transferee-initiated transfer of the blockchain token is permitted;
obtaining via the user device a user input comprising an indication of a first digital wallet address associated with the user and the user input causing a call to be transmitted from the user device to transfer the blockchain token from a second digital wallet address associated with a current owner of the blockchain token to the first digital wallet address associated with the user; and
displaying a representation that ownership of the blockchain token has been transferred to the user.

12. The system of claim 11, wherein:
the blockchain token is associated with a smart contract that comprises a transfer function that receives the call and transmits instructions to blockchain network to transfer the blockchain token from the current owner to the user; and
the call comprising the first digital wallet address.

13. The system of claim 12, wherein the smart contract permits transfer of the blockchain token based at least in part on receiving the call, unless the operations further comprise at least one of:
determining that a number of transfers of one or more blockchain tokens associated with a digital file to the first digital wallet address meets or exceeds a maximum number of transfers associated with a digital file per wallet address or for the digital file;
determining that a number of transferee-initiated transfers of the blockchain token meets or exceeds a maximum number of transferee-initiated transfers of the blockchain token;
determining an amount of transaction fees for transferring at least one of the blockchain token or one or more blockchain tokens associated with a digital file meets or exceed a maximum amount of transaction fees indicated by the smart contract or token data, or a current balance of a funding wallet indicated by the smart contract or token data associated with the blockchain token; or
determining that a code provided in association with the call does not match any of one or more codes indicated by the smart contract or the token data.

14. The system of claim 11, wherein:
the blockchain token comprises a uniform resource identifier (URI) or uniform resource locator (URL) that points to a digital file or metadata that comprises a link to the digital file; and
the operations comprise accessing the digital file via the digital wallet associated with the user and via the URI or URL responsive to receiving an indication that the blockchain token has been transferred to the user.

15. One or more non-transitory computer readable storage media storing one or more programs, the one or more programs comprising instructions, which when executed by one or more processors of an electronic device, cause the electronic device to perform operations comprising:
receiving a transfer function call identifying a blockchain token and a first blockchain wallet address different than a second blockchain wallet address associated with ownership of the blockchain token and including an instruction to transfer the blockchain token from the second blockchain wallet address to the first blockchain wallet address;
denying transferring of the blockchain token from the second blockchain wallet address to the first blockchain wallet address unless a smart contract associated with the blockchain token indicates transferee-initiated transfer of the blockchain token is permitted.

16. The one or more non-transitory computer readable storage media of claim 15, wherein the operations further comprise blocking the transfer function call in response to determining that the function caller is not the current owner of the blockchain token and did not mint the blockchain token.

17. The one or more non-transitory computer readable storage media of claim 15, wherein:
the blockchain token comprises a uniform resource identifier (URI) or uniform resource locator (URL) that points to a digital file or metadata that comprises a link to the digital file;
the operations further comprise transferring the blockchain token from the second blockchain wallet address to the first blockchain wallet address; and
the first blockchain wallet is permitted to access the digital file via the URI or URL based at least in part on the transfer.

18. The one or more non-transitory computer readable storage media of claim 15, wherein the transfer is denied, unless the operations further comprise determining that a number of transfers of one or more blockchain tokens associated with a digital file to the first blockchain wallet address is less than or equal to a maximum number of transfers associated with the digital file per wallet address or for the digital file.

19. The one or more non-transitory computer readable storage media of claim 15, wherein the transfer is denied, unless the operations further comprise at least one of:
determining that a number of transferee-initiated transfers of the blockchain token is less than or equal to a maximum number of transferee-initiated transfers of the blockchain token; or
determining an amount of transaction fees for transferring at least one of the blockchain token or one or more blockchain tokens associated with a digital file is less than or equal to a maximum amount of transaction fees indicated by the smart contract or token data, or a current balance of a funding wallet indicated by the smart contract or token data associated with the blockchain token.

20. The one or more non-transitory computer readable storage media of claim 15, wherein the transfer is denied, unless the operations further comprise determining that a code provided in association with the call matches any of one or more codes indicated by the smart contract or token data associated with the blockchain token.
